(19) United States
(12) Patent Application Publication
(10) Pub. No.: US 2023/0396819 A1
(43) Pub. Date: Dec. 7, 2023

(54) ANALYTIC- AND APPLICATION-AWARE VIDEO DERIVATIVE GENERATION TECHNIQUES

(71) Applicant: APPLE INC., Cupertino, CA (US)

(72) Inventors: Ke ZHANG, Mountain View, CA (US); Xiaoxia SUN, Santa Clara, CA (US); Shujie LIU, San Jose, CA (US); Xiaosong ZHOU, Campbell, CA (US); Jian LI, San Jose, CA (US); Xun SHI, San Jose, CA (US); Jiefu ZHAI, Sunnyvale, CA (US); Albert E KEINATH, Sunnyvale, CA (US); Hsi-Jung WU, San Jose, CA (US); Jingteng XUE, Cupertino, CA (US); Xingyu ZHANG, Mountain View, CA (US); Jun XIN, San Jose, CA (US)

(21) Appl. No.: 18/327,364

(22) Filed: Jun. 1, 2023

Related U.S. Application Data
(60) Provisional application No. 63/348,282, filed on Jun. 2, 2022.

(51) Int. Cl. H04N 21/2343; H04N 7/01; G06V 40/16; G06V 40/20; G06V 30/10; H04N 21/231

(52) U.S. Cl. CPC H04N 21/2343; H04N 7/0127; H04N 21/231; G06V 40/20; G06V 30/10; G06V 40/172

(57) ABSTRACT

A video delivery system generates and stores reduced bandwidth videos from source video. The system may include a track generator that executes functionality of application(s) to be used at sink devices, in which the track generator generates tracks from execution of the application(s) on source video and generates tracks having a reduced data size as compared to the source video. The track generator may execute a first instance of application functionality on the source video, which identifies region(s) of interest from the source video. The track generator further may downsample the source video according to downsampling parameters, and execute a second instance of application functionality on the downsampled video. The track generator may determine, from a comparison of outputs from the first and second instances of the application, whether the output from the second instance of application functionality is within an error tolerance of the output from the first instance of application functionality. If so, the track generator may generate a track from the downsampled video. In this manner, the system generates tracks that enable reliable application operation when processed by sink devices but also have reduced size as compared to source video.

### CLAIM FOR PRIORITY

The present disclosure benefits from priority of U.S. application s.n. 63/348,282, filed Jun. 2, 2022, entitled “Analytic- and Application-Aware Video Derivative Generation Techniques,” the disclosure of which is incorporated herein in its entirety.

### BACKGROUND

The present disclosure relates to media delivery systems and, in particular, to media delivery systems that require conservation of network resources between devices.

The proliferation of media data captured by audio-visual devices in daily life has become immense, which leads to significant problems in the exchange of such data in communication or computer networks. Device operators oftentimes capture video at the highest resolution, highest frame rate available, then exchange the video with remote devices for further processing. Those remote devices may not require video at such high levels of quality. Accordingly, the exchange of such videos consumes device and network resources unnecessarily.

### BRIEF DESCRIPTION OF THE DRAWINGS

FIG. 1 is a functional block diagram of a system according to an embodiment of the present disclosure.

FIG. 2 is a functional block diagram of a track generator according to an embodiment of the present disclosure.

FIG. 3 illustrates an exemplary frame from source video that may be processed by the track generator of FIG. 2.

FIG. 4 illustrates exemplary instances a region of interest that may be generated from the frame of FIG. 3.

FIG. 5 illustrates a method according to an embodiment of the present disclosure.

FIG. 6 is a block diagram of a system according to an aspect of the present disclosure.

### DETAILED DESCRIPTION

Embodiments of the present invention provide a video delivery system that generates and stores reduced-bandwidth videos (called “tracks,” for convenience) from source video. The system may include a track generator that executes functionality of application(s) to be used at sink devices, in which the track generator generates tracks from execution of the application(s) on source video and generates tracks having a reduced data size as compared to the source video. The track generator may execute a first instance of application functionality on the source video, which identifies region(s) of interest from the source video. The track generator further may downsample the source video according to downsampling parameters, and execute a second instance of application functionality on the downsampled video. The track generator may determine, from a comparison of outputs from the first and second instances of the application, whether the output from the second instance of application functionality is within an error tolerance of the output from the first instance of application functionality. If so, the track generator may generate a track from the downsampled video. In this manner, the system generates tracks that enable reliable application operation when processed by sink devices but also have reduced size as compared to source video.

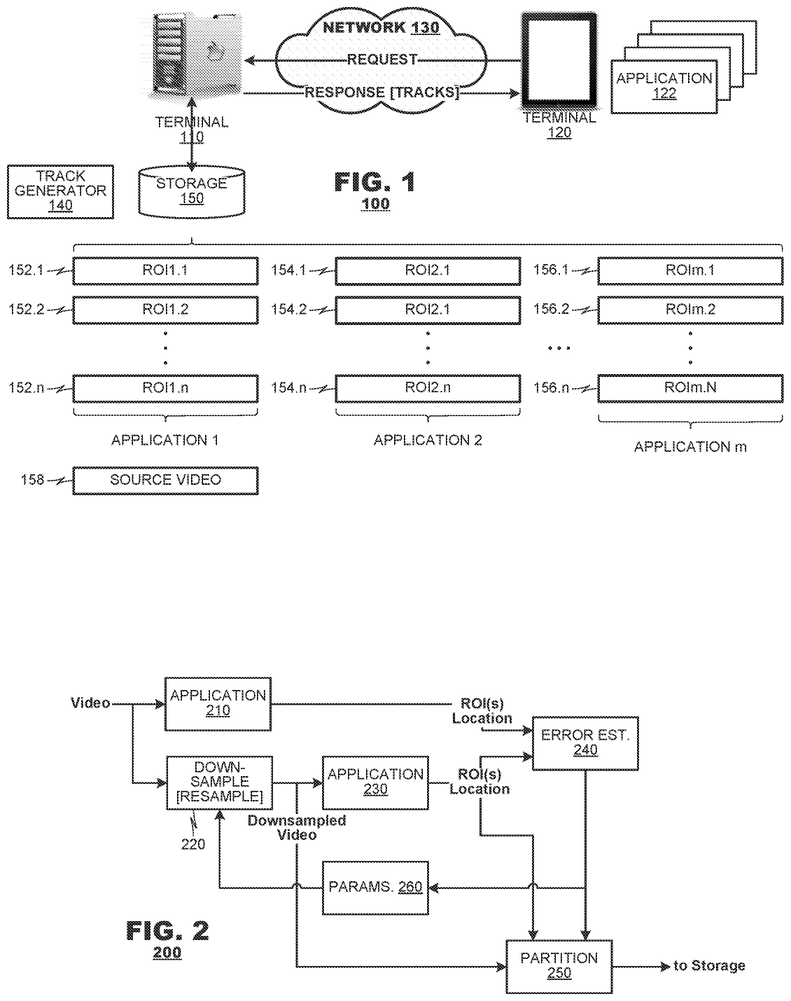

FIG. 1 illustrates a system 100 according to an embodiment of the present disclosure. The system 100 may include a source terminal 110 and a sink terminal 120 provided in mutual communication via a communication network 130. The source terminal 110 may include a track generator 140 that generates media items (called “tracks” herein) for storage 150 and delivery to sink terminals 120 upon request. The tracks 152.1-152.n, 154.1-154.n, 156.1-156.n may be generated from a source video 158 as described herein. Each track 152.1-152.n, 154.1-154.n, 156.1-156.n may be independently accessible by the sink terminal 120 and, as discussed below, may constitute a respective representation of a region of interest from the source video. If desired, the source video 158 that generates the tracks 152.1-152.n, 154.1-154.n, 156.1-156.n also may be stored at the source terminal 110 for delivery to sink terminals 120 upon request.

Although only one sink terminal 120 is illustrated in FIG. 1, it is expected that the source terminal 110 will support a variety of different sink terminals (not shown), which will use video content for different purposes. The sink terminals 120 are expected to execute a variety of different applications 122 each of which may process video for different needs using different processing algorithms. For example, different sink terminal applications 122 may perform one or more of the following processing operations on video: object type and/or motion recognition, human face recognition, human body and/or action recognition, animal recognition, text recognition, and the like. To support such applications, a track generator 140 may generate tracks according to the needs of the applications 112 that are expected to be executed by sink devices 120 throughout the system 100.

In an embodiment, content of a source video may be parsed into one or more regions of interest (ROIs) according to the needs of the different applications executed by sink devices 120 and tracks 152.1-152.n, 154.1-154.n, 156.1-156.n may be created therefrom the regions of interest at one or more resolutions. FIG. 1, for example, illustrates a first set of exemplary tracks 152.1-152.n for a first application, a second set of exemplary tracks 154.1-154.n for a second application, and another set of tracks 156.1-156.n for another application. In practice, the number of regions of interest that are generated are determined by the content of the source video 158 and the applications 1-m for which the tracks are developed; it may be an uncommon occurrence that a single source video 158 will generate an identical number n of tracks for every application being supported.

When content is stored as tracks 152.1-152.n, 154.1-154.n, 156.1-156.n, the content may be encoded according to bandwidth compression algorithms to reduce their sizes. Applications such as face recognition algorithms that require high resolution video may be coded by highly efficiency coding techniques, such as neural network-based encoders. Track codings also may contain metadata hints the assist client-side applications 122 to perform their processing operations.

The set of tracks 152.1-152.n, 154.1-154.n, 156.1-156.n, 158 illustrated in FIG. 1 are shown for a single source video 158. A source device 110 that generates tracks from multiple source videos 158 typically will generate respective sets of tracks as discussed herein.

Sink devices 120 may identify tracks for download in a variety of ways. In one embodiment, a sink device 120 may request a track by identifying the application for which the track is to be used, which a source device 110 may use to index and retrieve the track. Alternatively, the sink device 120 may identify a requested track by identifying a purpose for the video (e.g., face recognition); a source device 110 may track(s) that were generated for such purpose and supply the track. Alternatively, a source device 110 may supply to a sink device 120 a manifest file (not shown) that provides information regarding such tracks, such as the applications for which they created, their data rates, spatial resolutions, frame rates, etc. and the sink device 120 may select an appropriate track from options presented in the manifest file.

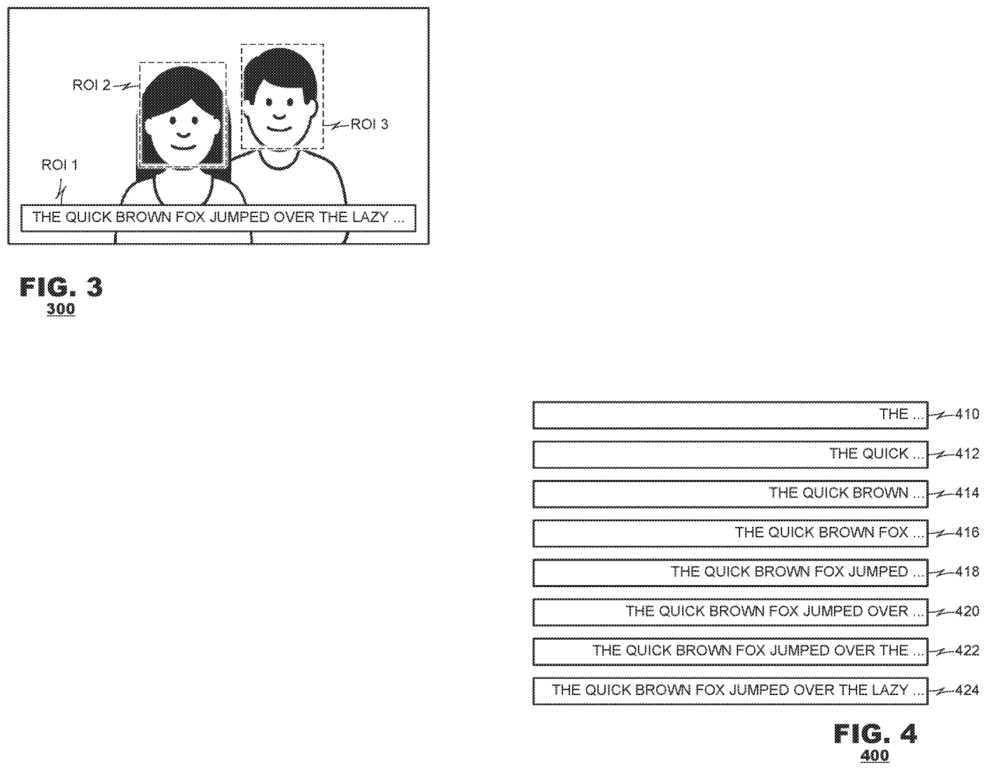

Tracks prepared as discussed herein may be used in a variety of use cases. In one instance, for example, processing of ROI-based tracks may support privacy initiatives in video conferencing, where it may be desired to obscure location-specific information from exchanged video when it is recovered and displayed. To support such an application, a sink device 120 may retrieve tracks corresponding to persons recognized in videos (see FIG. 3, discussed below) but without download of a source video in its entirety which may represent additional content beyond that of video conference participants (e.g., background information). The sink device 120 may compile renderable video from the recognized people that omits other source video content. In this manner, the rendered video may obscure background content that may reveal location information or other content that should remain confidential.

Tracks also may support frame rate conversion operations in certain embodiments. A sink device 120 may perform frame rate upconversion on a track that has low frame rate and is accompanied by metadata describing object motion at times provided between frames. In this manner, a client-side application may refine object motion estimates that would be obtained solely from content of track frames and thereby provide higher quality upconverted video.

Further, sink devices 120 may integrate content from multiple tracks into a composite user interface. A sink device 120, for example, may download a low-resolution trick-play video with high frame rate that represents motion of video content, and also download a high-resolution but low frame rate track that contains face crops at sample frames. The sink device 120 may merge these two representations into a common output interface.

FIG. 2 illustrates a functional block diagram of a track generator 200 according to an embodiment of the present disclosure. The track generator 200 may generate track(s) that are appropriate for consumption by an application 122 of a sink device 120 (FIG. 1). Tracks so generated may be stored at a source device 110 for delivery to the sink device upon request.

The track generator 200 may include a first instance of an application 210 that may identify region(s) of interest from a source video. The application 210 typically may contain functional elements that process video for the sink application's purpose. For example, if the track is intended for use with a face recognition application, the partitioning unit 210 may include functionality to recognize faces from video. So, too, with tracks intended for text recognition applications, action recognition applications, and the like; the first instance of the application 210 may include functionality corresponding to those applications. The application 210, however, need not include application functionality that is unrelated to the video-processing functionality for which tracks are generated.

The first instance of the application 210 may operate on video at a source resolution and it may output data identifying recognized content in the video. Continuing with the face recognition example, the application 210 may output data identifying face(s) that the application 210 recognizes and the location(s) within video where those face(s) are recognized. Recognized content may be processed as regions of interest within the track generator 200.

A downsampler 220 may downsample source video according to a set of downsampling parameters. Downsampling may occur via spatial downsampling, which typically reduces the resolution of source video (sometimes perceived as a reduction in the frames' sizes), by temporal downsampling, which causes a reduction of the video's frame rate, or both. The downsampler 220 may output a downsampled copy of the source video to a second instance of the application 230.

The second instance of the application 230 may process the downsampled video according to its operation. As with the first instance 210 of the application, it is expected that the second application 230 will be provided to perform a predetermined action on video, such as performing face recognition, object recognition, action recognition, text recognition, or the like. And, as with the first instance of the application 210, the second instance of the application 230 may output data identifying the region(s) of interest recognized from input video (this time, the downsampled video) and their location(s). But, again, the second instance of the application 230 need not have functionality of sink device applications 122 (FIG. 1) that are unrelated to video processing.

An error estimator 240 may compare region of interest data from the first and second instances of the application 210, 230. The error estimator 240 may determine whether the recognized regions of interest and locations information from the two application instances agree with each other within a predetermined range of error. If so, the video output by the downsampler 220 may be processed into tracks and placed in storage. Specifically, a partitioning unit 250 may generate cropped versions of the downsampled video that correspond to the regions of interest identified by the second instance of the application 230.

If the error estimator 240 determines that the recognized regions of interest and locations information from the two application instances do not agree with each other, the error estimator 240 may cause a parameter generator 260 to revise downsampling parameters. In this manner, the downsampler 220 may generate a new version of downsampled source video and operation of the second instance of the application 230 and the error estimator 240 may repeat.

It is expected that the track generator 200 will converge on a set of downsampling parameters that cause the second instance of the application 230 to operate reliably upon downsampled video obtained from the downsampler 220. Such convergence will lead to generation of tracks that induce reliable operation of an application at a sink device 120 (FIG. 1) yet conserve network resources as compared to transmission of a source video.

The error estimator 240 also may perform other estimates of application errors. Some sink device applications 122 (FIG. 1), for example, may perform frame rate upconversion as part of their video processing; in such an application, an error estimator 240 may determine upconversion errors by comparing upconverted video generated by the second instance of the application 230 with source video. Downsampling parameters may be revised when inappropriate errors are detected.

FIG. 3 illustrates an exemplary frame 300 from source video that may be processed by the track generator 200 (FIG. 2). In this example, the source video includes content corresponding to two people and “crawling” text as is familiar from broadcasts that carry news, sports, and/or financial markets information. Different instances of the text generator 200 may be applied to the source video, for example, to recognize faces in the content and to recognize the text.

In this example, when text recognition is applied to the source video, a first region of interest ROI1 may be identified therefrom. The downsampler may downsample the source video both spatially and temporally. Spatial downsampling parameters may be determined to converge appropriately when characters from the text crawl are properly recognized. Temporal downsampling parameters may be determined to converge appropriately when the frames of new text character's appearance or new word's appearance are properly recognized. For example, frames in which individual characters (or words) are presented only partially may be removed from the track.

FIG. 4 illustrates exemplary instances 410-424 of ROI1 (FIG. 3) that may be generated by the track generator 200 of FIG. 2. In this example, the track generator 200 is configured to generate a track that contains information to reliably recognize individual words as they appear in content. In this instance, the applications 210, 230 (FIG. 2) may generate data identifying when new whole words appear in text. Frames that contain incomplete words would not be recognized as having new text. In this example, the track generator 200 may generate a track for ROI1 that includes frames 410-424 in which new whole words are recognized but in which other frames of source video appearing interstitially between these frames 410, 412, . . . , 424 may be removed. Removal of these interstitial frames may reduce the size of a track for ROI1 considerably over the size of the source video from which it is generated, which may conserve resources in a streaming application. Cropping content of the frame 300 (FIG. 3) in regions outside the region of interest ROI1 also leads to a smaller-sized track for ROIL

The example of FIG. 3 also illustrates content of two people, which may lead to creation of tracks therefor when the track generator 200 (FIG. 2) is applied for face recognition applications. Here, again, tracks for the two faces may be cropped to match the spatial locations where the faces ROI2, ROI3 are recognized, and they may be spatially and/or temporally downsampled to reduce resource consumption when used in a system 100 and yet still provide for reliable operation and sink devices 120.

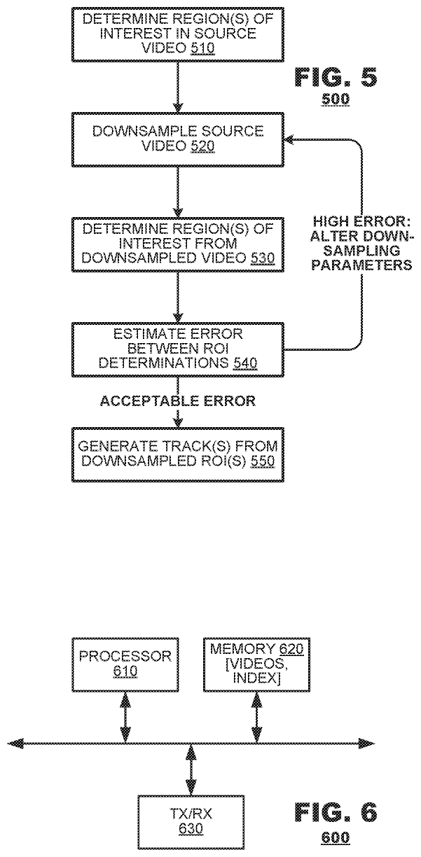

FIG. 5 illustrates a method 500 according to an embodiment of the present disclosure. The method 500 may begin by determining region(s) of interest in source video according to an application process (box 510). The method 500 may downsample source video (box 520). The method 500 may determine region(s) of interest from the downsampled video (box 530) and estimate an error between the region of interest determinations made in box 510 and in box 530. If the error is estimated as being within an acceptable range, the method may generate track(s) from the downsampled region(s) of interest obtained from the downsampling (box 550). If not, the method 500 may alter downsampling parameters and return to box 520 and perform the operation of boxes 520-540 in another iteration.

FIG. 6 is a block diagram of a device 600 according to an aspect of the present disclosure. The device 600 may find application as the system 100 of FIG. 1. The device 600 may include a processor 610 and a memory 620. The memory 620 may store program instructions that define an operating system and various applications that are executed by the processor 610, including, for example, track generator 140 (FIG. 1). The memory 620 also may function as storage 140 (FIG. 1) storing tracks generated by the track generator 140. The memory 620 may include a computer-readable storage media such as electrical, magnetic, or optical storage devices.

The device 600 may possess a transceiver system 630 to communicate with other system components, for example, sink devices 120 (FIG. 1). The transceiver system 630 may communicate with sink devices 120 over a wide variety of wired or wireless electronic communications networks.

Although the source device (FIG. 1) is illustrated as embodied in a server, the principles of the present disclosure are not so limited. The principles of the present disclosure find application with a variety of electronic devices such as personal computers, laptop computers, tablet computers, media servers, gaming systems, and the like.

Embodiments of the present disclosure also find application with on-device generation of video tracks in which tracks are generated and consumed by a common device. In such applications, certain processing operation such as video coding/decoding and video scaling may be performed with less resource consumption than would occur when performing such operations on source video from which the tracks are generated. Moreover, use of tracks may enable fast seeking to items of interest such as recognized people, video detected as having face(s) and/or video having recognized text. The techniques described herein find application in local processing operations where the tracks are generated and processed on a common device.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure. The present specification describes components and functions that may be implemented in particular embodiments, which may operate in accordance with one or more particular standards and protocols. However, the disclosure is not limited to such standards and protocols. Such standards periodically may be superseded by faster or more efficient equivalents having essentially the same functions. Accordingly, replacement standards and protocols having the same or similar functions are considered equivalents thereof.

We claim:

1. A method of generating tracks for use in media delivery, comprising:
executing a first instance of application functionality on a source video, the executing identifying at least one region of interest from the source video,
downsampling the source video according to downsampling parameters,
executing a second instance of application functionality on the downsampled video,
comparing output from the first and second instances of the application,
when the output from the second instance of application functionality is within an error tolerance of the output from the first instance of application functionality, generating a track from the downsampled video, and
storing the track.

2. The method of claim 1, further comprising, processing the stored track by an application that possesses the application functionality.

3. The method of claim 1, further comprising, sending the stored track to a remote device upon request.

4. The method of claim 1, further comprising, processing the stored track on a common device at the track is generated.

5. The method of claim 1, further comprising, when the output from the second instance of application functionality is outside the error tolerance of the output from the first instance of application functionality, revising the downsampling parameters and repeating the executing and the comparing.

6. The method of claim 1, wherein the application functionality comprises video processing functionality of an application to be executed in the sink device.

7. The method of claim 6, wherein the application functionality comprises object recognition.

8. The method of claim 6, wherein the application functionality comprises face recognition.

9. The method of claim 6, wherein the application functionality comprises animal recognition.

10. The method of claim 6, wherein the application functionality comprises action recognition.

11. The method of claim 6, wherein the application functionality comprises text recognition.

12. The method of claim 1, wherein the downsampling includes spatial downsampling of the source video.

13. The method of claim 1, wherein the downsampling includes temporal downsampling of the source video.

14. The method of claim 1, wherein generating the track includes cropping the downsampled video according to a location of a region of interest detected in the downsampled video.

15. The method of claim 1, wherein the generating the track includes cropping the downsampled video according to a location of a region of interest detected in the downsampled video.

16. The method of claim 1, wherein the track has a lower frame rate than a frame rate of the source video.

17. Computer readable medium having stored thereon program instructions that, when executed by a processing device, case the device to:
execute a first instance of application functionality on a source video, the executing identifying at least one region of interest from the source video,
downsample the source video according to downsampling parameters,
execute a second instance of application functionality on the downsampled video,
compare output from the first and second instances of the application,
when the output from the second instance of application functionality is within an error tolerance of the output from the first instance of application functionality, generate a track from the downsampled video, and
storing the track for later delivery to another device.

18. The medium of claim 17, wherein, when the output from the second instance of application functionality is outside the error tolerance of the output from the first instance of application functionality, the program instructions cause the device to revise the downsampling parameters and repeating the executing and the comparing.

19. The medium of claim 17, wherein the application functionality comprises video processing functionality of an application to be executed in the sink device.

20. The medium of claim 19, wherein the application functionality comprises object recognition.

21. The medium of claim 19, wherein the application functionality comprises face recognition.

22. The medium of claim 19, wherein the application functionality comprises animal recognition.

23. The medium of claim 19, wherein the application functionality comprises action recognition.

24. The medium of claim 19, wherein the application functionality comprises text recognition.

25. The medium of claim 17, wherein the downsampling includes spatial downsampling of the source video.

26. The medium of claim 17, wherein the downsampling includes temporal downsampling of the source video.

27. The medium of claim 17, wherein generating the track includes cropping the downsampled video according to a location of a region of interest detected in the downsampled video.

28. The medium of claim 17, wherein the generating the track includes cropping the downsampled video according to a location of a region of interest detected in the downsampled video.

29. The medium of claim 17, wherein the track has a lower frame rate than a frame rate of the source video.

30. A video delivery system, comprising:
a track generator executing application(s) corresponding to application(s) to be used at sink devices, the track generator to generate tracks from execution of the application(s) on source video, the tracks having a reduced data size as compared to the source video,
a storage and retrieval system to store tracks from the generator as separately accessible data elements and to furnish the tracks to a sink device upon request.
